(19) United States
(12) Patent Application Publication
(10) Pub. No.: US 2011/0262243 A1
(43) Pub. Date: Oct. 27, 2011

(54) SELF-CONTAINED TWIST FASTENER FOR INSTALLATION AND SERVICE ACCESS

(76) Inventor: David Brian Glickman, Southfield, MI (US)

(21) Appl. No.: 12/765,063

(22) Filed: Apr. 22, 2010

(51) Int. Cl. F16B 21/02; F16B 21/00

(52) U.S. Cl. 411/337; 411/349; 411/347

(57) ABSTRACT

A fastener assembly on a removable vehicle part. A removable vehicle part is provided to be fastened. A fastener is inserted through a portion of the removable vehicle part to be fastened. A receiver is formed having engagement catches. The fastener is removably connected to the receiver to form a fastener assembly. The engagement catches of the receiver of the fastener assembly are inserted into a vehicle.

### FIELD OF THE INVENTION

The present invention generally relates to a self-contained twist fastener for installation and service access, and more particularly relates to

### BACKGROUND OF THE PRESENT INVENTION

Many parts on a vehicle are secured by removable fastener. The fasteners are often poorly constructed and weak, which results in the fasteners being broken or discarded.

### SUMMARY OF THE PRESENT INVENTION

One aspect of the present invention includes a method for using a fastener assembly on a removable vehicle part. First, a removable vehicle part is provided that is to be fastened to a vehicle. A fastener is inserted through a portion of the removable vehicle part to be fastened. A receiver is formed having engagement catches. The fastener is removably connected to the receiver to form a fastener assembly. The engagement catches of the receiver of the fastener assembly are inserted into a vehicle.

Another aspect of the present invention includes a method of making a fastening system for use in a vehicle. A fastener is formed including an engagement portion having first and second engagement members. The fastener is extended through an item to be fastened. A receiver is formed having receiving slots adapted to receive the first and second engagement members of the fastener. A rear projection is formed in the receiver that is adapted to secure the fastening system to the vehicle.

Yet another aspect of the present invention includes a fastening system having a fastener including an engagement portion having planar engagement members. A receiver includes slots to receive the planar engagement members of the fastener. A rear projection extends from the receiver to secure the receiver to a vehicle. Initial installation of the fastening system results in permanent connection of the receiver to the vehicle, but removable connection of the fastener to the receiver.

These and other aspects, objects, and features of the present invention will be understood and appreciated by those skilled in the art upon studying the following specification, claims, and appended drawings.

### BRIEF DESCRIPTION OF THE DRAWINGS

FIG. 1 is a top perspective view of a vehicle incorporating one embodiment of a fastener assembly of the present invention;

FIG. 2 is a bottom perspective view of one embodiment of a fastener assembly of the present invention;

FIG. 3 is a bottom perspective exploded view of one embodiment of a fastener assembly of the present invention;

FIG. 4 is a bottom perspective view of one embodiment of a fastener of the present invention;

FIG. 5 is a top perspective view of the fastener of FIG. 4;

FIG. 6 is a bottom plan view of the fastener of FIG. 4;

FIG. 7 is a side elevational view of the fastener of FIG. 4;

FIG. 8 is a top plan view of the fastener of FIG. 4;

FIG. 9 is a bottom perspective view of one embodiment of a receiver of the present invention;

FIG. 10 is a top perspective view of the receiver of FIG. 9;

FIG. 11 is a bottom plan view of the receiver of FIG. 9;

FIG. 12 is a side elevational view of the receiver of FIG. 9;

FIG. 13 is a top plan view of the receiver of FIG. 9;

FIG. 14 is a bottom perspective view of the fastener engaged with the receiver to form a fastener assembly in an unlocked position;

FIG. 15 is a bottom perspective view of the fastener assembly of FIG. 14 taken at lines XV-XV;

FIG. 16 is a top perspective view of the fastener assembly of FIG. 14;

FIG. 17 is a top perspective cross-sectional view of the fastener assembly of FIG. 14 taken at lines XVII-XVII;

FIG. 18 is a bottom plan view of the fastener assembly of FIG. 14;

FIG. 19 is a side elevational view of the fastener assembly of FIG. 14;

FIG. 20 is a top plan view of the fastener assembly of FIG. 14;

FIG. 21 is a bottom perspective view of a fastener assembly in a locked position;

FIG. 22 is a bottom perspective cross-sectional view of the fastener assembly of FIG. 21 taken at lines XXII-XXII;

FIG. 23 is a top perspective view of the fastener assembly of FIG. 21;

FIG. 24 is a bottom perspective cross-sectional of the fastener assembly of FIG. 21 taken at lines XIV-XIV;

FIG. 25 is a bottom plan view of the fastener assembly of FIG. 21;

FIG. 26 is a side elevational view of the fastener assembly of FIG. 21;

FIG. 27 is a top plan view of the fastener assembly of FIG. 21;

FIG. 28 is a top perspective view of one embodiment of a fastener assembly prior to initial installation of a vehicle part;

FIG. 29 is a side elevational view of the fastener assembly of FIG. 28 prior to installation;

FIG. 30 is a top perspective view of the fastener assembly of FIG. 28 after engagement with the vehicle part;

FIG. 31 is a side elevational view of the fastener assembly of FIG. 30 after installation of the vehicle part;

FIG. 32 is a top perspective view of the fastener assembly of FIG. 30 after installation of the vehicle part with the vehicle and the vehicle part in hidden line;

FIG. 33 is a bottom perspective view of the fastener assembly of FIG. 30 after installation of the vehicle part;

FIG. 34 is a top perspective view of the fastener assembly of FIG. 30 during temporary removal of the vehicle part; and

FIG. 35 is a side elevational view of the fastener assembly of FIG. 30 during temporary removal of the vehicle part.

### DETAILED DESCRIPTION OF EMBODIMENTS

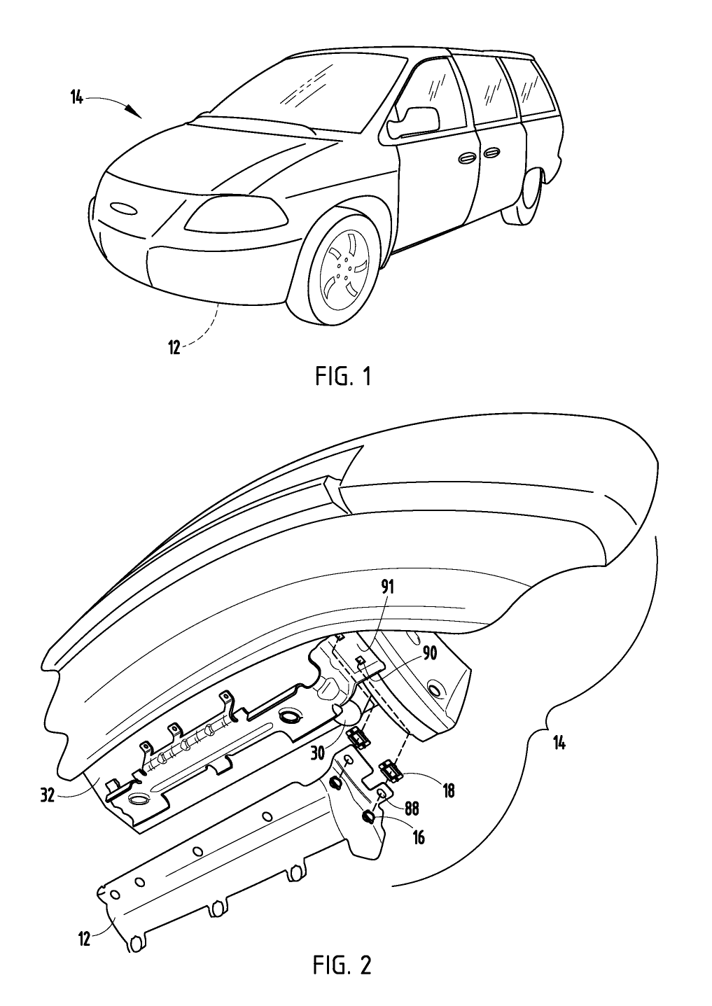

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

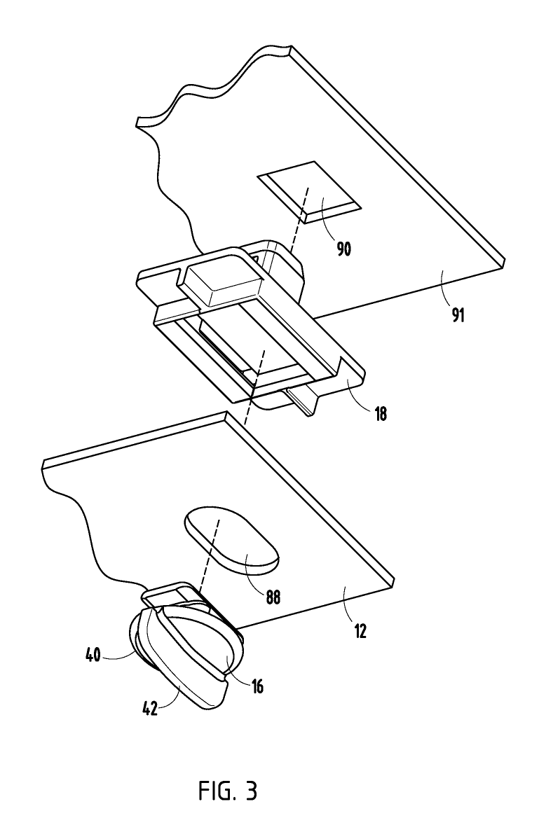

Referring to FIGS. 1-3, reference numeral 10 generally designates a fastener assembly for a removable vehicle part 12. The removable vehicle part 12 is to be fastened to a vehicle 14. A fastener 16 is inserted through a portion of the removable vehicle part 12 to be fastened. A receiver 18 is formed having engagement catches 20. The fastener 16 is removably connected to the receiver 18 to form the fastener assembly 10. The engagement catches 20 of the receiver 18 of the fastener assembly 10 are inserted into the vehicle 14.

Referring again to FIGS. 1-3, the fastener assembly 10 is designed for use in any of a variety of vehicles 14 that have temporarily removable parts. For example, as shown in FIG. 2, the fastener assembly 10 is connected with a wind deflector and provides easy access to an oil filter 30 that is located below or proximate to an engine block 32 of the vehicle 14. Traditional push fasteners or screw fasteners are often difficult to remove and reinstall and are easily damaged. However, the fastener assembly 10 as disclosed herein provides easy quarter turn removal and reinstallation of the removable vehicle part 12 (in this case, a wind deflector positioned below the vehicle 14). The two parts of the fastener assembly 10, specifically the fastener 16 and the receiver 18, are designed to sandwich the removable vehicle part 12 that is being installed. In addition, the receiver 18 is designed to permanently engage the vehicle 14, as discussed in further detail below.

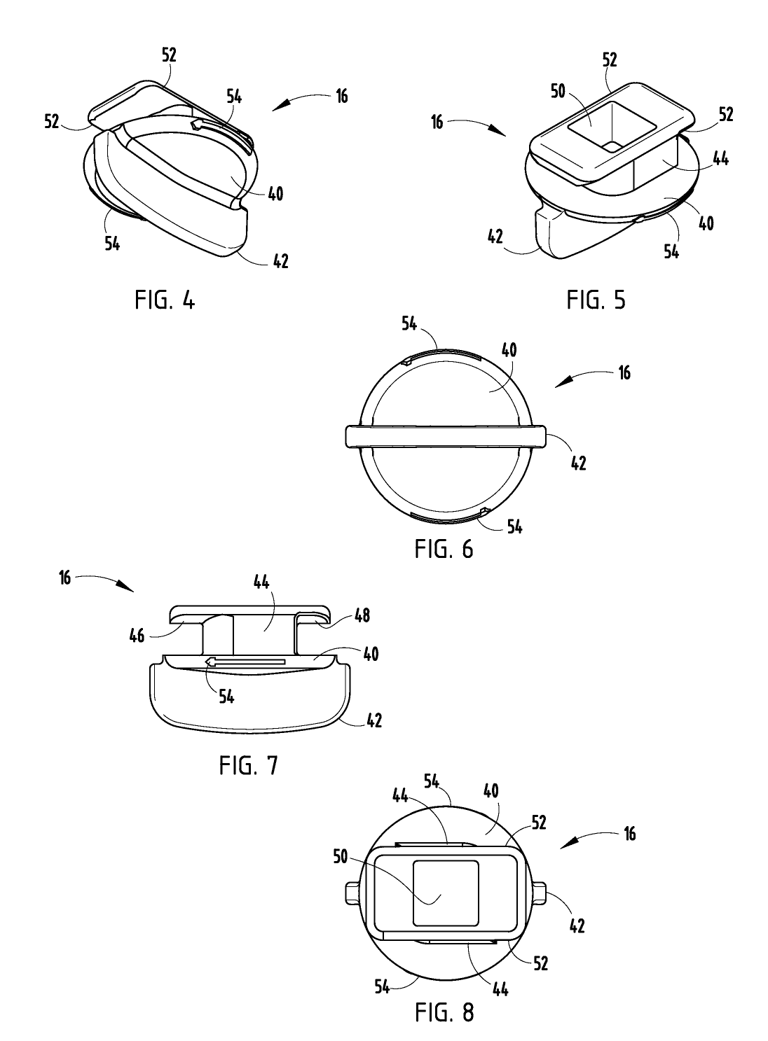

Referring now to FIGS. 4-8, the fastener 16 includes a circular base 40 with a downwardly extending linear finger grip 42. It is contemplated that the linear finger grip 42 may take a variety of constructions and may extend all the way across the circular base 40 or only a portion of the circular base 40. The linear finger grip 42 is adapted for, and has a height specifically designed for, finger turning by a user. Accordingly, tools or other devices are not necessary to rotate the fastener 16 during connection with the receiver 18. As shown in FIGS. 6 and 8, the linear finger grip 42 extends beyond the diameter of the circular base 40 to provide additional gripping surface to a user, although it is contemplated that the length of the linear finger grip 42 could vary. The fastener 16 also includes an engagement portion 44 that extends from a top side of the circular base 40, and which includes first and second planar engagement members 46, 48 that extend laterally therefrom. The first and second planar engagement members 46, 48 extend in a direction parallel with the longitudinal extent of the linear finger grip 42, however, it is contemplated that the first and second planar engagement members 46, 48 could also be oriented orthogonally to the linear finger grip 42.

Referring again to FIGS. 4-8, an aperture 50 is disposed in the engagement portion 44 and assists in reducing the overall weight of the fastener 16 and reducing the amount of material needed to construct the fastener 16. The first and second planar engagement members 46, 48 include edges 52 that are slightly tapered to ease turning of the fastener 16 during installation and removal of the fastener 16 from the receiver 18. The circular base 40 also includes directional arrows 54 that are molded onto the circular base 40, and which indicate to a user which way the fastener 16 needs to be rotated to be temporarily removed from the receiver 18. It is contemplated that the arrows 54 could be painted or in the form of an appliqué, etc.

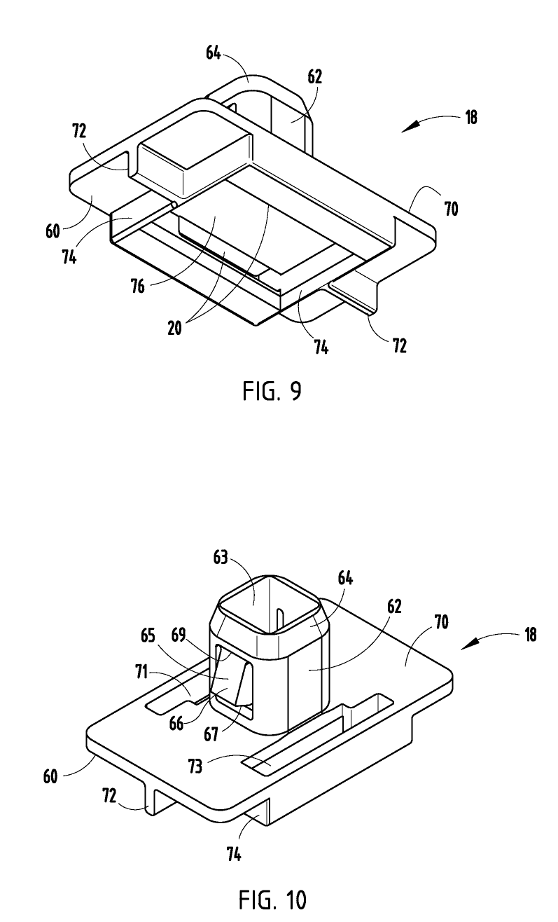

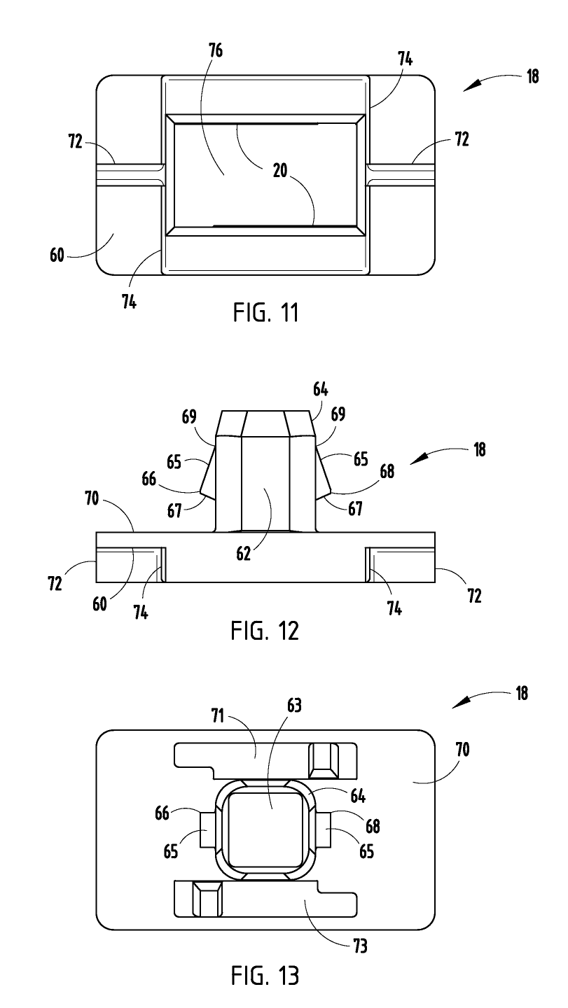

Referring now to FIGS. 9-13, the receiver 18 includes a rectangular base 60 and a rear projection 62 extending upwardly therefrom. The rear projection 62 defines a central cavity 63. The rear projection 62 includes a beveled edge 64, as well as first and second interference fit protrusions 66, 68 that extend from opposing sides of the rear projection 62. The first and second interference fit protrusions 66, 68 are disposed on flexibly resilient arms 69 formed in the rear projection 62. In the illustrated embodiment shown in FIG. 10, the first and second interference fit protrusions 66, 68 are in the form of triangular catches that extend from the rear projection 62, and which are designed to permanently connect the receiver 18 to the vehicle 14. The triangular catches include an engagement face 65 and an abutment face 67, which are discussed in greater detail below. A bottom side 70 of the rectangular base 60 includes first and second receiving slots 71, 73 that form the engagement catches 20 and are adapted to receive the first and second planar engagement members 46, 48 of the fastener 16. The bottom side 70 of the rectangular base 60 includes support flanges 72 that abut support walls 74 and that provide structural rigidity to the rectangular base 60. It will be understood by one having ordinary skill in the art that additional support flanges 72 and support walls 74 may be provided. The engagement catches 20 and the support walls 74 define a rectangular recess 76 designed to receive the engagement portion 44 and the first and second planar engagement members 46, 48 of the fastener 16.

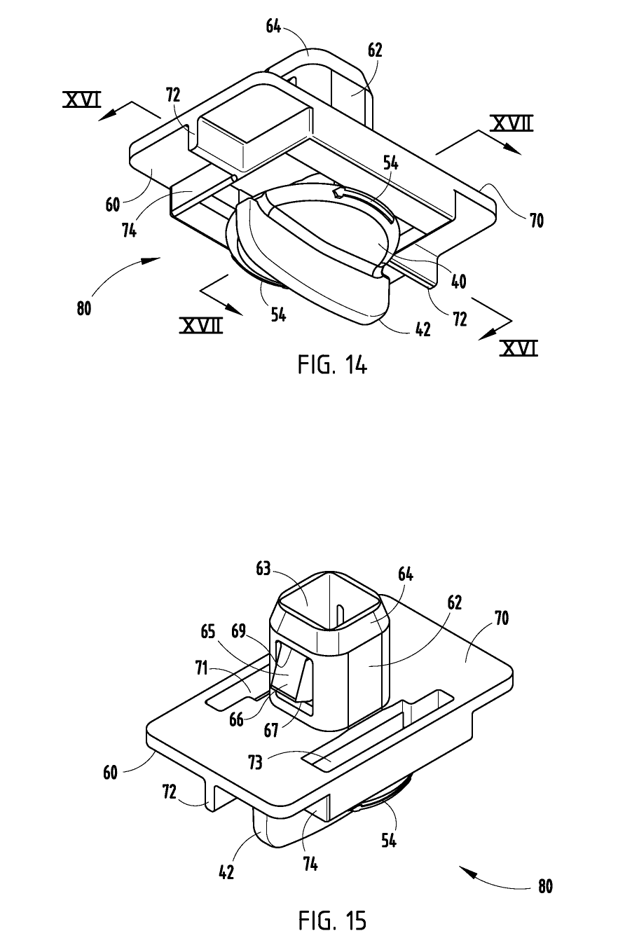

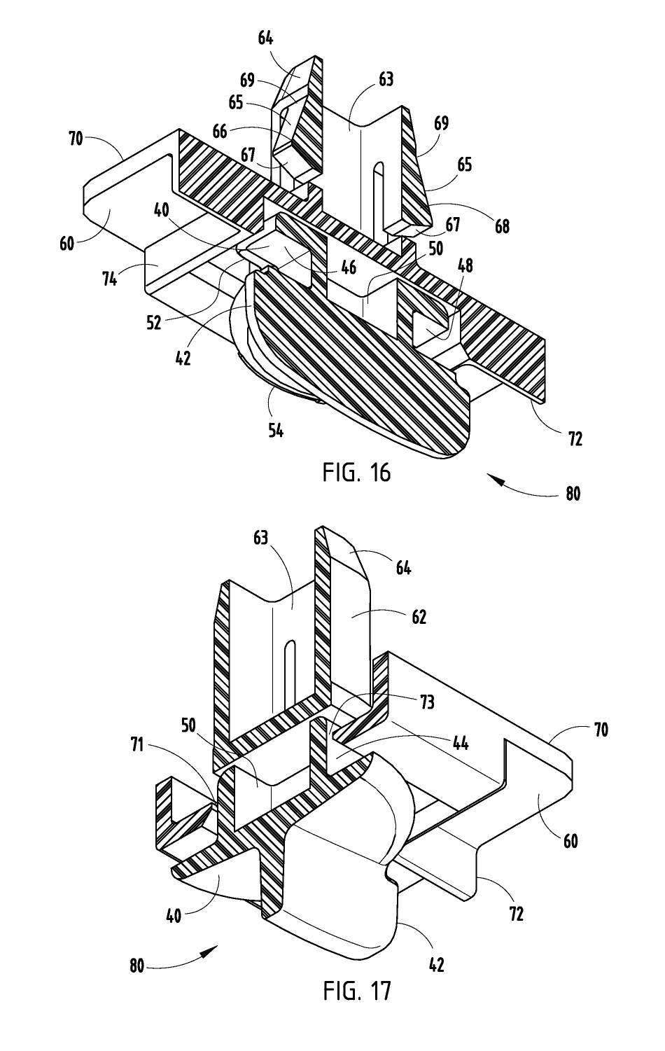

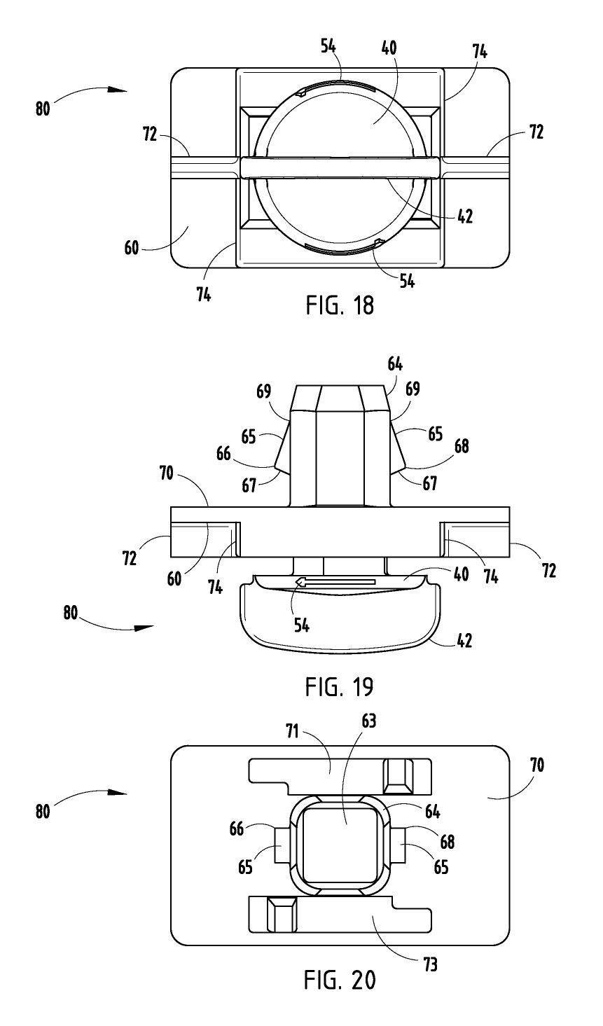

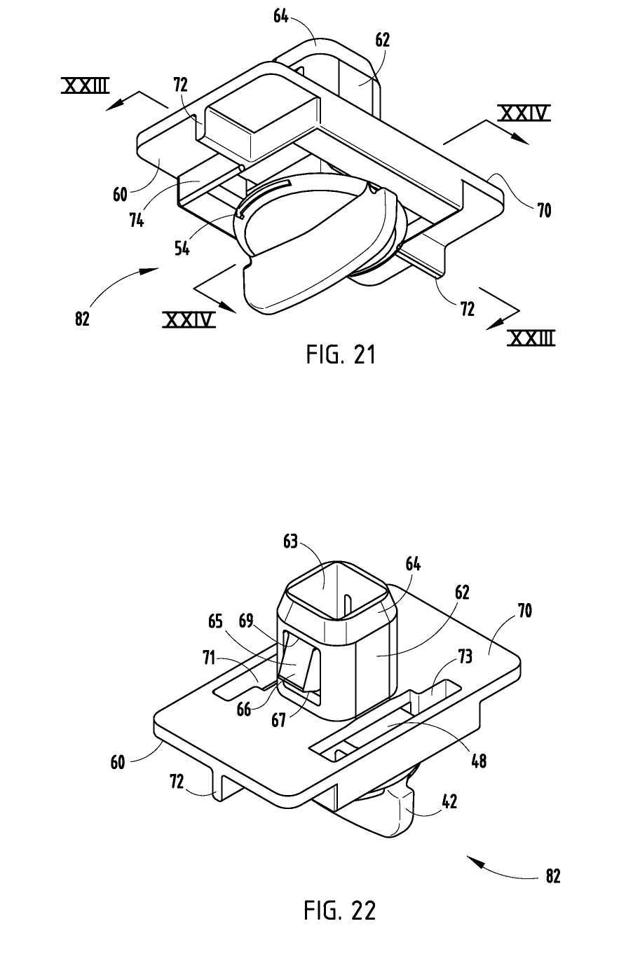

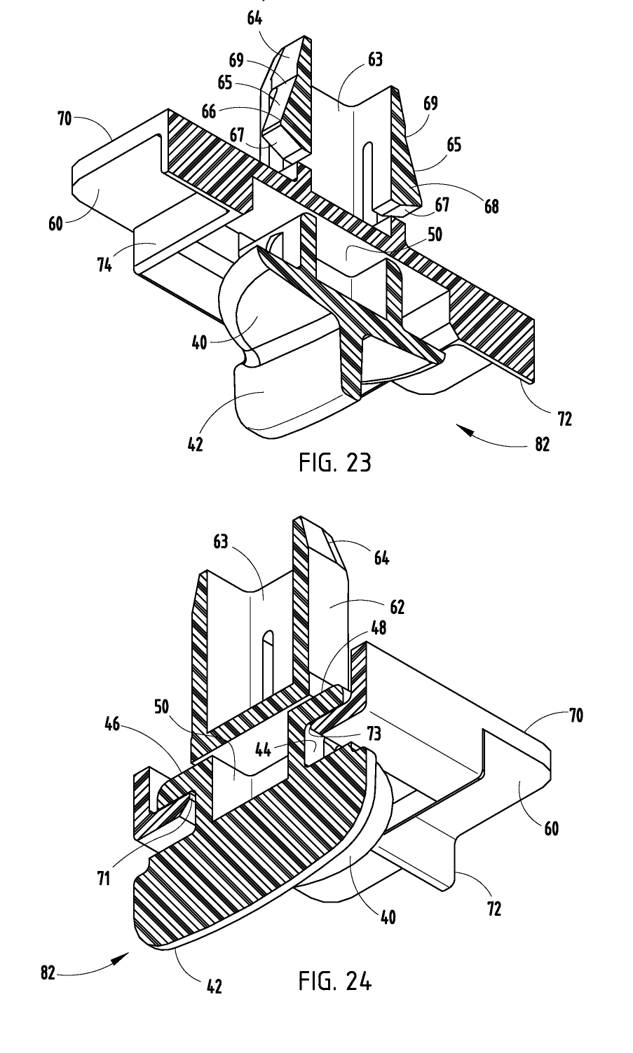

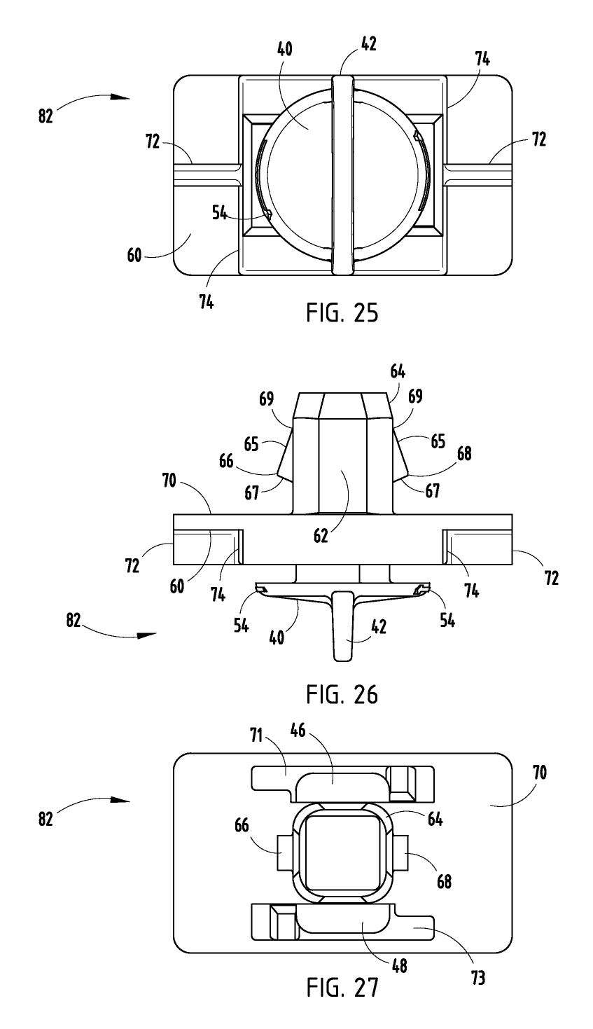

Referring now to FIGS. 14-20, during installation of the fastener 16 into the receiver 18, the fastener 16 is inserted into the rectangular recess 76 in the bottom side 70 of the rectangular base 60 of the receiver 18. The fastener 16 can only be inserted into the rectangular recess 76 in the bottom side 70 of the rectangular base 60 when properly aligned with the rectangular recess 76. Once the fastener 16 is properly aligned and resting inside the receiver 18, the fastener assembly 10 is in an unlocked position 80. From the unlocked position 80, the fastener 16 can be rotated one quarter turn, or 90 degrees, in the direction opposite of arrows 54, which consequently causes the first and second planar engagement members 46, 48 to rotate into the first and second receiving slots 71, 73, respectively, thus frictionally engaging the fastener 16 to the receiver 18. The fastener assembly 10 is now in a locked position 82. Once the fastener 16 is held in place, a simple quarter turn in the direction of the arrows 54 will allow rotation of the fastener 16 relative to the receiver 18, such that the first and second planar engagement members 46, 48 of the engagement portion 44 can once again be aligned with the rectangular recess 76 in the bottom side 70 of the rectangular base 60. When the first and second planar engagement members 46, 48 are aligned with the rectangular recess 76, the fastener assembly 10 is once again in the unlocked position 80, and the fastener 16 can be withdrawn from the rectangular recess 76 in the bottom side 70 of the rectangular base 60.

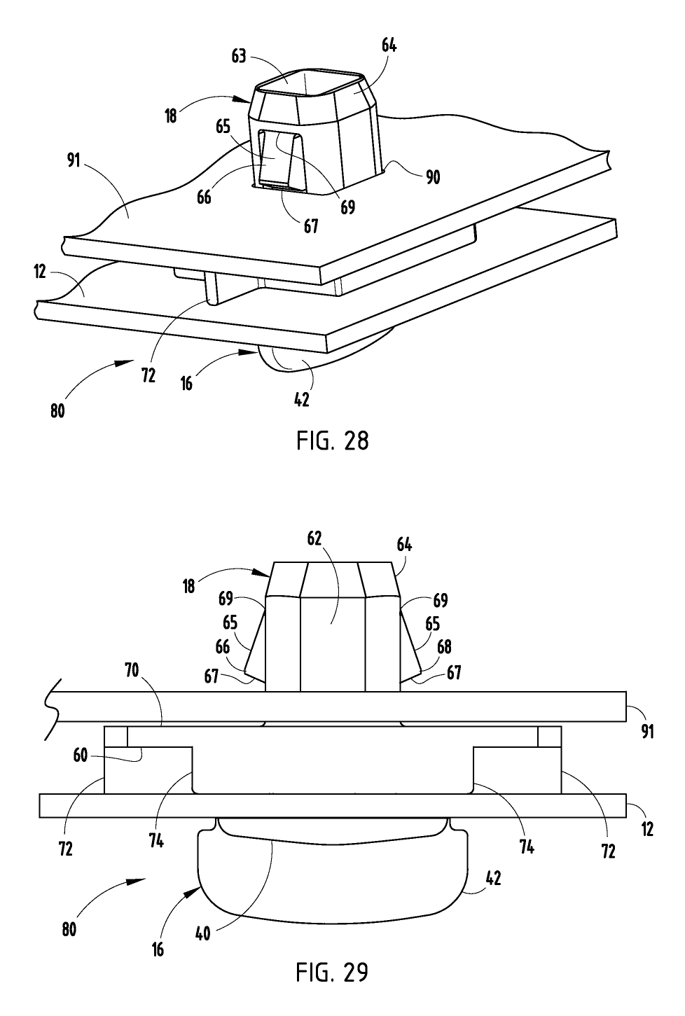

Referring now to FIGS. 28 and 29, during initial installation of the removable vehicle part 12, the removable vehicle part 12 will be supplied with the fastener assembly 10 already attached thereto. To attach the removable vehicle part 12 to the fastener assembly 10, the engagement portion 44 of the fastener 16 is inserted through an aperture 88 in the removable vehicle part 12. The engagement portion 44 is then aligned with the rectangular recess 76 of the receiver 18 and rotated into engagement with the receiver 18. More specifically, the fastener assembly 10 is in the locked position 82 with the fastener 16 engaged with the receiver 18, and the removable vehicle part 12 is disposed between the circular base 40 of the fastener 16 and the rectangular base 60 of the receiver 18.

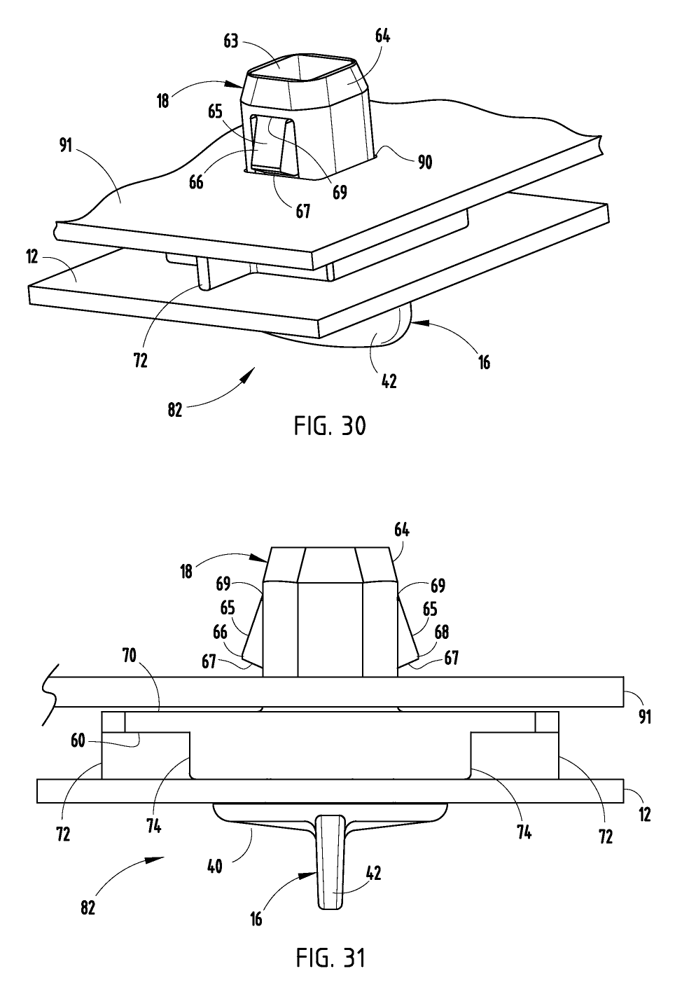

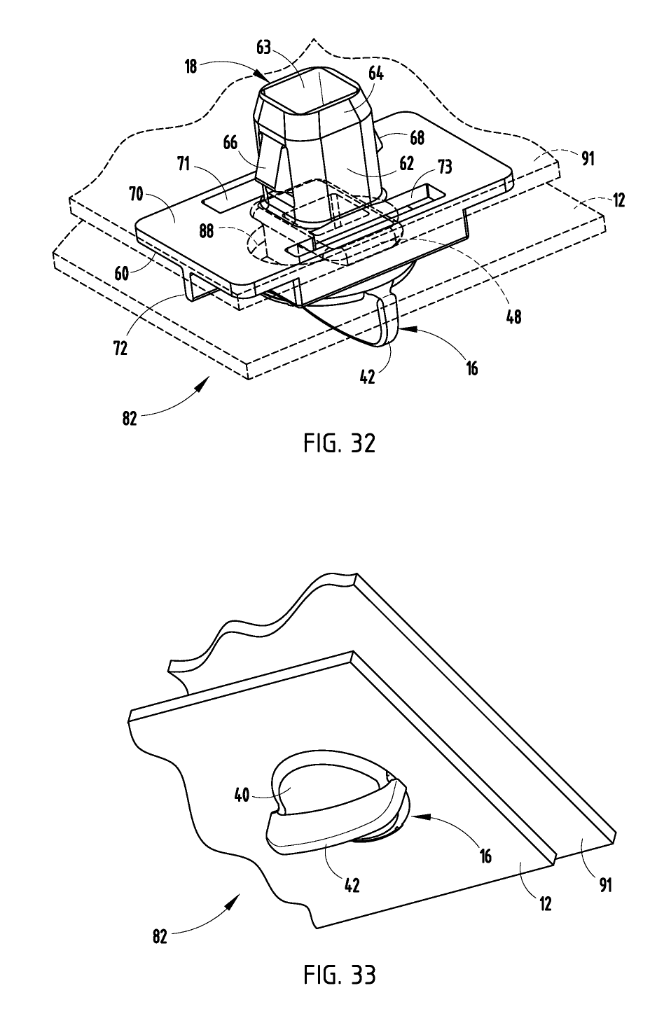

Referring now to FIGS. 30-33, for initial installation of the removable vehicle part 12 to the vehicle 14, the installer needs only to force the rear projection 62 of the receiver 18 into a receiving aperture 90 defined by a vehicle wall 91 in the vehicle 14 sized to receive the rear projection 62. When the installer forces the rear projection 62 into the receiving aperture 90, the engagement face 65 of the first and second interference fit protrusions 66, 68 engage sides of the receiving aperture 90. The sides of the receiving aperture 90 force the engagement face 65 inward, which causes the resilient arms 69 to flex inward into the central cavity 63 until the first and second interference fit protrusions 66, 68 pass through the receiving aperture 90 and snap outward under the spring bias of the resilient arms 69. The abutment force 67 of the first and second interference fit protrusions 66, 68 now abut a back side of the wall 91 that defines the receiving aperture 90. As discussed above, once the rear projection 62 has been inserted into the receiving aperture 90, the receiver 18 is permanently lodged in the receiving aperture 90 and cannot be easily removed. Accordingly, the removable vehicle part 12 is now fully installed, as shown in FIGS. 30-33.

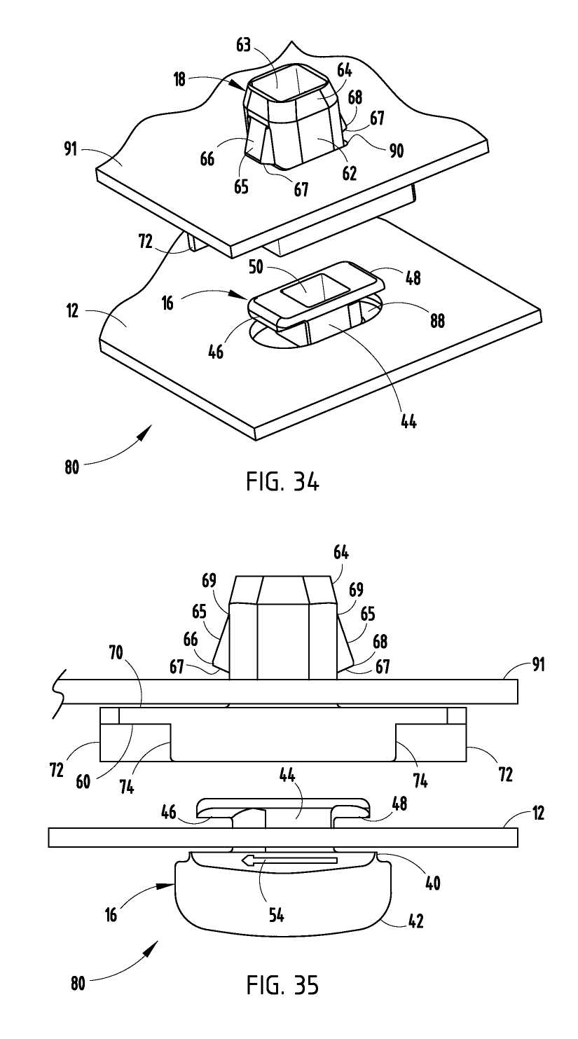

To service or repair the removable vehicle part 12, as shown in FIGS. 34 and 35, the fastener 16 is rotated 90 degrees relative to the receiver 18, as discussed in detail above, such that the removable vehicle part 12 and the fastener 16 are allowed to be withdrawn from contact with the vehicle 14. In this way, the oil filter 30 can be readily accessed, removed, and a new oil filter 30 can be installed. It is contemplated that other removable vehicle parts 12, such as wind deflectors and protecting shields, can utilize this quick connect fastener assembly 10, which is designed to provide easy access to the interior workings of the vehicle 14. In addition, it is contemplated that the fastener 16 may include a tactile or audible indicia that notifies a user when the fastener 16 has been placed in the locked position 82 or the unlocked position 80.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method of using a fastener assembly on a removable vehicle part, comprising:
providing a removable vehicle part to be fastened;
inserting a fastener through a portion of the removable vehicle part to be fastened;
forming a receiver having engagement catches;
removably connecting the fastener to the receiver to form a fastener assembly; and
inserting the engagement catches of the receiver of the fastener assembly into a vehicle.

2. The method of claim 1, further comprising:
rotating the fastener relative to the receiver to disconnect the fastener from the receiver.

3. The method of claim 1, further comprising:
forming a laterally extending engagement member that extends from the fastener.

4. The method of claim 1, wherein the step of providing a removable vehicle part to be fastened further comprises:
providing a wind deflector as the removable vehicle part to be fastened.

5. The method of claim 1, further comprising:
forming a linear finger grip on the fastener.

6. A method of making a fastening system for use in a vehicle comprising:
forming a fastener including an engagement portion having first and second engagement members;
extending the fastener through a removable vehicle part to be fastened;
forming a receiver having receiving slots adapted to receive the first and second engagement members of the fastener; and
forming a rear projection in the receiver that is adapted to secure the fastening system to the vehicle.

7. The method of claim 6, further comprising:
rotating the fastener relative to the receiver to disconnect the fastener from the receiver.

8. The method of claim 6, wherein the step of providing a removable vehicle part to be fastened further comprises:
providing a wind deflector as the removable vehicle part to be fastened.

9. The method of claim 8, further comprising:
positioning the fastener, receiver, and wind deflector proximate an oil filter of the vehicle.

10. The method of claim 6, further comprising:
forming a linear finger grip that extends from the fastener.

11. The method of claim 6, further comprising:
forming triangular catches that extend from at least one side of the rear projection that permanently connect the receiver to the vehicle.

12. The method of claim 6, further comprising:
forming support flanges on the receiver proximate the first and second receiving slots.

13. A fastening system, comprising:
a fastener including an engagement portion having planar engagement members;
a receiver having slots to receive the planar engagement members of the fastener; and
a rear projection extending from the receiver to secure the receiver to a vehicle, wherein initial installation of the fastening system results in permanent connection of the receiver to the vehicle, but removable connection of the fastener to the receiver.

14. The fastening system of claim 13, wherein a wind deflector is disposed between the fastener and the receiver.

15. The fastening system of claim 13, wherein the fastener, receiver and wind deflector are disposed proximate an oil filter of the vehicle.

16. The fastening system of claim 13, wherein the planar engagement members extend laterally relative to the longitudinal extent of the fastener.

17. The fastening system of claim 13, further comprising:
a linear finger grip extending from the fastener.

18. The fastening system of claim 13, wherein the rear projection includes triangular catches extending from at least one side of the rear projection that permanently connect the receiver to the vehicle.

19. The fastening system of claim 13, wherein the receiver includes support flanges disposed proximate the first and second receiving slots.

20. The fastening system of claim 13, wherein the rear projection of the receiver is hollow.
